(19) United States
(12) Patent Application Publication
(10) Pub. No.: US 2022/0131259 A1
(43) Pub. Date: Apr. 28, 2022

(54) VEHICLE ANTENNA MOUNTING SYSTEM

(71) Applicants: HYUNDAI MOTOR COMPANY, Seoul (KR); KIA CORPORATION, Seoul (KR); ACE TECHNOLOGIES CORPORATION, Incheon (KR)

(72) Inventors: Byoung Hyun Lee, Yongin-si (KR); Se Young Park, Seoul (KR); Sang Ho Lee, Hwaseong-si (KR); Jin Kyu Hwang, Incheon (KR)

(73) Assignees: HYUNDAI MOTOR COMPANY, Seoul (KR); KIA CORPORATION, Seoul (KR); ACE TECHNOLOGIES CORPORATION, Incheon (KR)

(21) Appl. No.: 17/403,442

(22) Filed: Aug. 16, 2021

(30) Foreign Application Priority Data
Oct. 26, 2020 (KR) 10-2020-0139589

(51) Int. Cl. H01Q 1/32

(52) U.S. Cl. CPC H01Q 1/3275

(57) ABSTRACT

A vehicle antenna mounting system, including an antenna circuit board, an antenna base supporting the antenna circuit board, an antenna cover covering the antenna circuit board, and a temporary mounting member temporarily mounting the antenna base on a roof of a vehicle body. The antenna base has a mounting projection protruding downwardly from a bottom surface of the antenna base and a cavity defined in the mounting projection. The temporary mounting member is received in the cavity and the roof has a hole into which the temporary mounting member is inserted.

### CROSS-REFERENCE TO RELATED APPLICATION

This application is based on and claims the benefit of priority to Korean Patent Application No. 10-2020-0139589, filed on Oct. 26, 2020, in the Korean Intellectual Property Office, the disclosure of which is incorporated herein in its entirety by reference.

### TECHNICAL FIELD

The present disclosure relates to a vehicle antenna mounting system, and more particularly, to a vehicle antenna mounting system capable of preventing the separation of an antenna base from the roof of a vehicle before the antenna base is fully connected to a roof of a vehicle body through a bolt and a nut.

### BACKGROUND

A vehicle may have a vehicle antenna for communications, and the vehicle antenna may be mounted on a roof of a vehicle body through a bolt and a nut.

The vehicle antenna may include an antenna circuit board, an antenna base supporting the antenna circuit board, and an antenna cover covering the antenna circuit board. The antenna circuit board may have a plurality of antenna elements, patch antennas, and the like for communications, signal transmission and reception, and the like. The antenna base may be mounted on the roof of the vehicle body through the bolt and the nut, and the antenna cover may protect the antenna circuit board.

The antenna base may be temporarily mounted on the roof of the vehicle by a plurality of temporary mounting members. Then the antenna base may be fully connected to the roof of the vehicle by the bolt and the nut.

The plurality of temporary mounting members may be connected to the antenna base by a plurality of screws. As the plurality of temporary mounting members are inserted into a hole of the roof, the antenna base may be temporarily assembled to the roof.

However, when the antenna base is connected to the roof by the bolt and the nut, each temporary mounting member may easily be separated from the hole of the roof, which makes the assembly of the vehicle antenna difficult.

In addition, as the plurality of temporary mounting members are connected to the antenna base by the plurality of screws, the costs of components/parts, processing, and the like may increase.

As the plurality of temporary mounting members protrude upwardly from the antenna base, the plurality of temporary mounting members may interfere with the elements of the circuit board, which may reduce a circuit pattern usage rate of the circuit board.

The above information described in this background section is provided to assist in understanding the background of the inventive concept, and may include any technical concept which is not considered as the prior art that is already known to those having ordinary skill in the art.

### SUMMARY

The present disclosure has been made to solve the above-mentioned problems occurring in the prior art while maintaining advantages achieved by the prior art.

An aspect of the present disclosure provides a vehicle antenna mounting system capable of preventing an antenna base from being separated from a roof of a vehicle body by tightly fastening the antenna base using fasteners (e.g., a bolt and a nut) in a state in which the antenna base and the roof are temporarily assembled and connected through a temporary mounting member.

According to an aspect of the present disclosure, a vehicle antenna mounting system may include: an antenna circuit board; an antenna base supporting the antenna circuit board; an antenna cover covering the antenna circuit board; and a temporary mounting member temporarily mounting the antenna base on a roof of a vehicle body. The antenna base may have a mounting projection protruding downwardly from a bottom surface of the antenna base and a cavity defined in the mounting projection. The temporary mounting member may be received in the cavity and the roof may have a hole into which the temporary mounting member is inserted.

The temporary mounting member may include: a head; a pair of center legs extending from the center of the head; and a pair of edge legs extending from both edges of the head, respectively.

The pair of center legs may be spaced apart from each other and be parallel to each other. Each center leg may be elastically bent and connected to the head and the center leg may have a center retention barb provided on a bottom end thereof.

Each edge leg may have an edge retention barb provided on a bottom end thereof.

Each edge leg may have an inner surface facing the pair of center legs and an outer surface facing the outside of the head. The edge leg may have a plurality of inner recesses provided on the inner surface and a plurality of outer recesses provided on the outer surface.

The plurality of inner recesses may be recessed from the inner surface toward the outer surface and the plurality of outer recesses may be recessed from the outer surface toward the inner surface.

The edge retention barb may have a first inclined surface and a second inclined surface opposing the first inclined surface. A slope of the first inclined surface may be steeper than that of the second inclined surface.

The head may have a positioning recess and the antenna base may have a positioning projection protruding toward the cavity. When the temporary mounting member is received in the cavity, the positioning projection may be fitted into the positioning recess.

The cavity may include: an upper cavity receiving the head; a center cavity receiving the pair of center legs; and a pair of edge cavities receiving the pair of edge legs, respectively.

The cavity may include a retention shoulder provided in the center cavity. The pair of center legs may be engaged with the retention shoulder.

When the head is received in the upper cavity, a top surface of the head may be flush with a top surface of the antenna base.

Each edge leg may further include a straight portion extending vertically.

The temporary mounting member may have a head and an opening provided in the head and may include a pair of edge legs extending from both edges of the head, respectively. A screw may pass through the opening and be screwed into the antenna base.

The vehicle antenna mounting system may further include a stopper projection protruding downwardly from a bottom surface of the roof along a peripheral edge of the hole.

### BRIEF DESCRIPTION OF THE DRAWINGS

The above and other objects, features, and advantages of the present disclosure should be more apparent from the following detailed description taken in conjunction with the accompanying drawings:

FIG. 1 illustrates an exploded perspective view of a vehicle antenna mounting system according to an embodiment of the present disclosure;

FIG. 2 illustrates a perspective view of a temporary mounting member in a vehicle antenna mounting system according to an embodiment of the present disclosure;

FIG. 3 illustrates a front view of the temporary mounting member illustrated in FIG. 2;

FIG. 4 illustrates a side view of the temporary mounting member illustrated in FIG. 2;

FIG. 5 illustrates a perspective view of an antenna base for a vehicle antenna according to an embodiment of the present disclosure;

FIG. 6 illustrates a perspective view of the separation of the temporary mounting member from a cavity of the antenna base illustrated in FIG. 5;

FIG. 7 illustrates a plan view of the antenna base illustrated in FIG. 6;

FIG. 8 illustrates a side view of the antenna base illustrated in FIG. 7;

FIG. 9 illustrates a cross-sectional view taken along line A-A of FIG. 8;

FIG. 10 illustrates a state in which center legs and edge legs of the temporary mounting member are initially received in a cavity;

FIG. 11 illustrates a state in which center legs of a temporary mounting member are bent by a retention shoulder;

FIG. 12 illustrates a state in which a temporary mounting member has fully been received in a cavity;

FIG. 13 illustrates a state before a stud bolt of an antenna base is inserted into a hole of a roof of a vehicle body;

FIG. 14 illustrates an enlarged view of a stud bolt of an antenna base and a hole of a roof of a vehicle body;

FIG. 15 illustrates a cross-sectional view of a state before a stud bolt of an antenna base is inserted into a hole of a roof;

FIG. 16 illustrates a cross-sectional view of a state in which a temporary mounting member and a stud bolt of an antenna base are passing through a hole of a roof;

FIG. 17 illustrates a cross-sectional view of a state in which a temporary mounting member and a stud bolt of an antenna base have fully been inserted into a hole of a roof;

FIG. 18 illustrates a perspective view of a state in which a stud bolt of an antenna base fully extends downward through a hole of a roof before a nut is tightly fastened;

FIG. 19 illustrates a cross-sectional view of a state in which an antenna base is fully connected to a roof as a nut is tightly fastened to a stud bolt of the antenna base;

FIG. 20 illustrates an enlarged view of portion B of FIG. 19;

FIG. 21 illustrates an exploded perspective view of a vehicle antenna mounting system according to another embodiment of the present disclosure;

FIG. 22 illustrates a cross-sectional view of a state in which a temporary mounting member is fastened by a screw in a vehicle antenna mounting system according to another embodiment of the present disclosure;

FIG. 23 illustrates a cross-sectional view of a vehicle antenna mounting system according to another embodiment of the present disclosure;

FIG. 24 illustrates a perspective view of the temporary mounting member illustrated in FIG. 23;

FIG. 25 illustrates a front view of the temporary mounting member illustrated in FIG. 24; and

FIG. 26 illustrates a side view of the temporary mounting member illustrated in FIG. 24.

### DETAILED DESCRIPTION

Hereinafter, embodiments of the present disclosure are described in detail with reference to the accompanying drawings. In the drawings, the same reference numerals are used throughout to designate the same or equivalent elements. In addition, a detailed description of well-known techniques associated with the present disclosure have been omitted in order not to unnecessarily obscure the gist of the present disclosure.

Terms such as first, second, A, B, (a), and (b) may be used to describe the elements in embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those having ordinary skill in the field of art to which the present disclosure belongs. Such terms as those defined in a generally used dictionary are to be interpreted as having meanings consistent with the contextual meanings in the relevant field of art. Such terms are not to be interpreted as having ideal or excessively formal meanings unless clearly defined as having such in the present application.

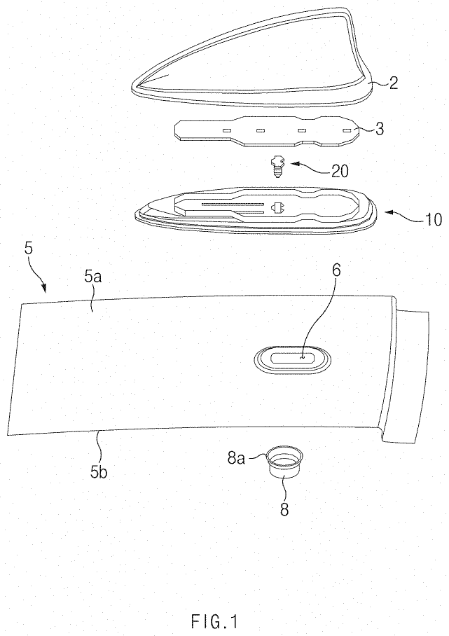

FIG. 1 illustrates an exploded perspective view of a vehicle antenna mounting system according to an embodiment of the present disclosure.

Referring to FIG. 1, a vehicle antenna according to an embodiment of the present disclosure may include an antenna circuit board 3, an antenna base 10 supporting the antenna circuit board 3, and an antenna cover 2 covering the antenna circuit board 3.

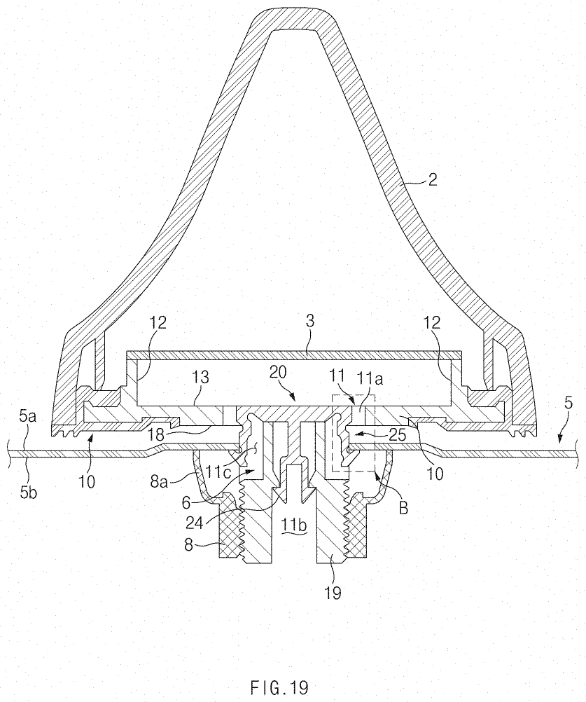

The antenna circuit board 3, the antenna base 10, and the antenna cover 2 may constitute the vehicle antenna. The antenna circuit board 3 may have a plurality of antenna elements, patch antennas, and the like for communications, signal transmission and reception, and the like. Referring to FIG. 19, the antenna base 10 may be completely mounted on a roof 5 of a vehicle body through a stud bolt 19 and a nut 8. The antenna cover 2 may protect the antenna circuit board 3.

The vehicle antenna mounting system according to an embodiment of the present disclosure may include a temporary mounting member 20 for temporarily mounting the antenna base 10 on the roof 5 of the vehicle body.

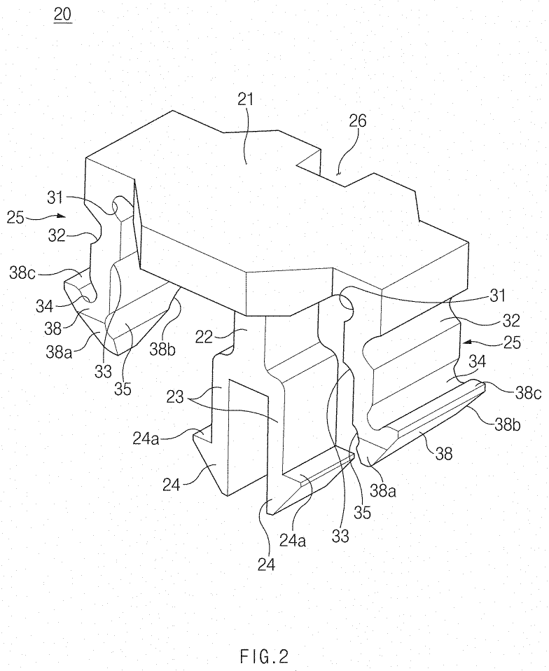

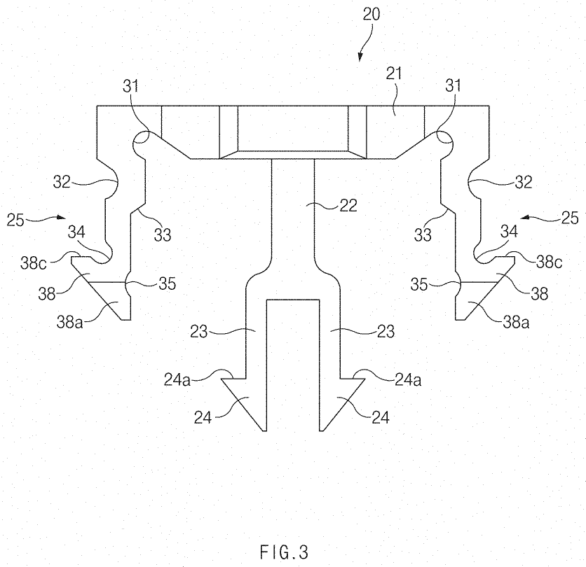

Referring to FIGS. 2-4, the temporary mounting member may include a head 21, a center extension portion 22 extending from the center of the head 21, a pair of center legs 23 extending from the center extension portion 22, and a pair of edge legs 25 extending from both edges of the head 21.

The center extension portion 22 may extend vertically from the head 21 and the pair of center legs 23 may be connected to a bottom end of the center extension portion 22. The pair of center legs 23 may be spaced apart from each other and be parallel to each other. Each center leg 23 may be integrally connected to the bottom end of the center extension portion 22 and the pair of center legs 23 may be connected to the head 21 through the center extension portion 22. The center legs 23 may be elastically bent (deformed). Each center leg 23 may have a center retention barb 24 provided on a bottom end thereof and the center retention barb 24 may have a flat engagement surface 24a.

Each edge leg 25 may have an inner surface facing the pair of center legs 23 and an outer surface facing the outside of the head 21. In particular, the edge leg 25 may have a plurality of inner recesses 31, 33, and 35 which are recessed from the inner surface toward the outer surface and may have a plurality of outer recesses 32 and 34 which are recessed from the outer surface toward the inner surface. The plurality of inner recesses 31, 33, and 35 may face the center of the head 21 and the plurality of outer recesses 32 and 34 may face the outside of the head 21. Accordingly, each edge leg 25 may have curves by the plurality of inner recesses 31, 33, and 35 and the plurality of outer recesses 32 and 34.

The plurality of inner recesses 31, 33, and 35 may include a first inner recess 31 located on a top end of each edge leg 25, a second inner recess 33 located below the first inner recess 31, and a third inner recess 35 located below the second inner recess 33. The plurality of outer recesses 32 and 34 may include a first outer recess 32 located between the first inner recess 31 and the second inner recess 33 and may include a second outer recess 34 located between the second inner recess 33 and the third inner recess 35.

Each edge leg 25 may have an edge retention barb 38 provided on a bottom end thereof and the edge retention barb 38 may have a flat engagement surface 38c.

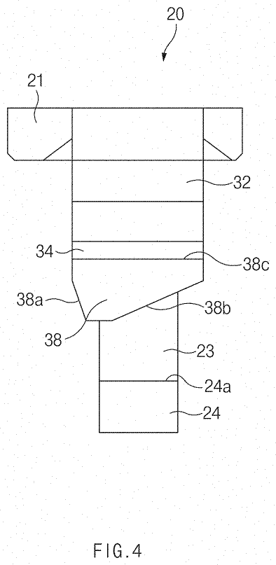

Referring to FIGS. 2 and 4, the edge retention barb 38 may have a first inclined surface 38a and a second inclined surface 38b opposing the first inclined surface 38a. For example, the first inclined surface 38a may face the front of the temporary mounting member 20 or the front of the vehicle and the second inclined surface 38b may face the rear of the temporary mounting member 20 or the rear of the vehicle. A slope of the first inclined surface 38a may be steeper than that of the second inclined surface 38b. In other words, the first inclined surface 38a and the second inclined surface 38b may have an asymmetrical shape.

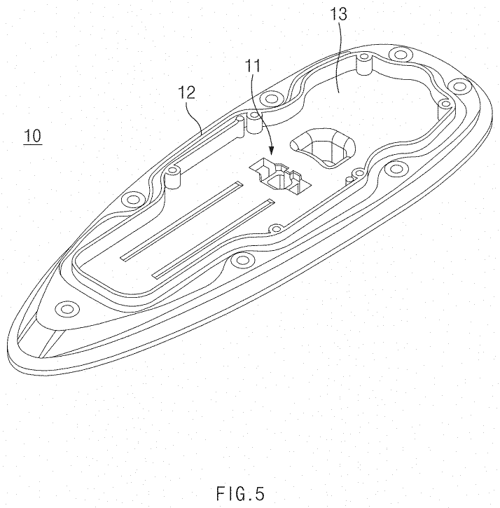

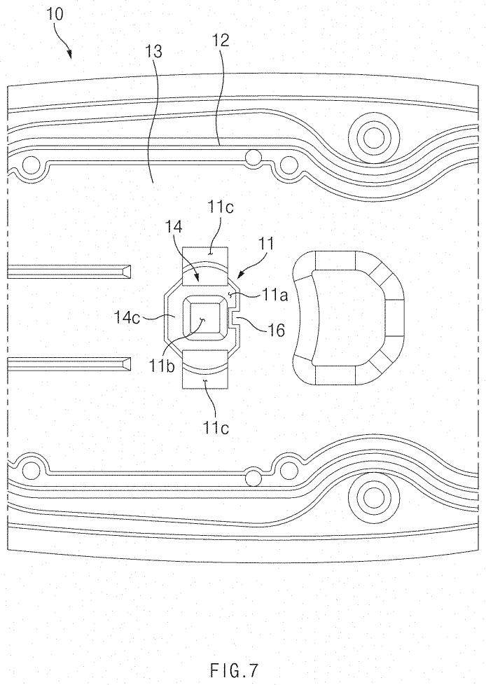

Referring to FIGS. 5-17, the antenna base 10 may include a top surface 13, a bottom surface 18 opposing the top surface 13, a support wall 12 extending along an edge of the top surface 13, and a sealing portion 17 extending along an edge of the bottom surface 18.

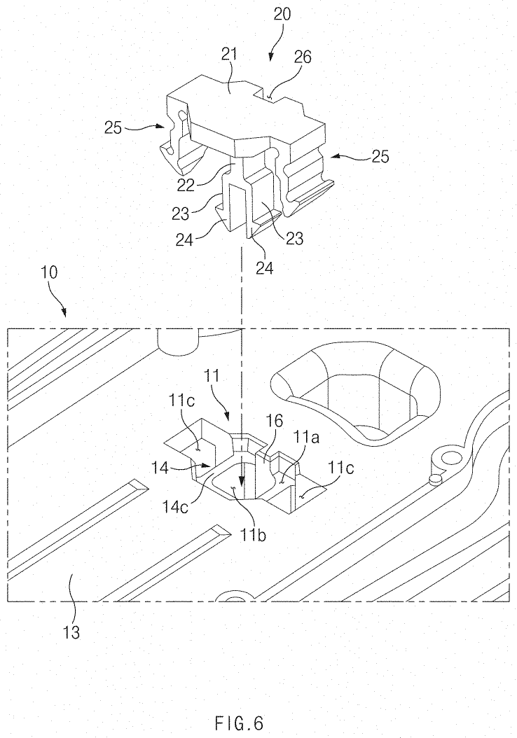

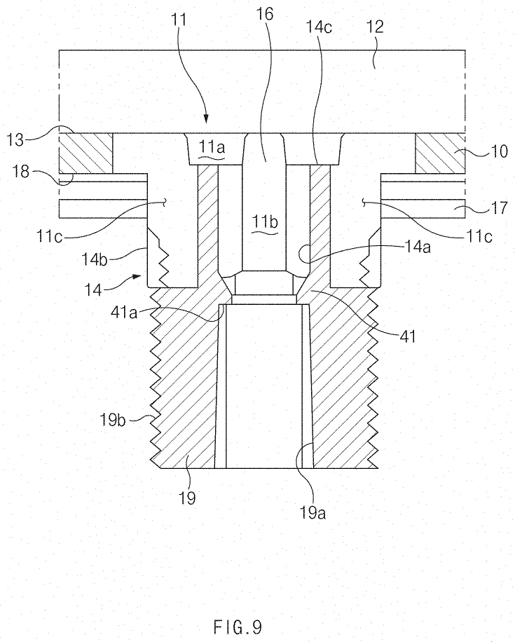

Referring to FIGS. 6 and 9, the antenna base 10 may have a cavity 11 in which the temporary mounting member 20 is received. The cavity 11 may be recessed from the top surface 13 of the antenna base 10 toward the bottom surface 18 of the antenna base 10. The cavity 11 may include an upper cavity 11a receiving the head 21, a center cavity 11b receiving the center extension portion 22 and the pair of center legs 23, and a pair of edge cavities 11c receiving the pair of edge legs 25, respectively.

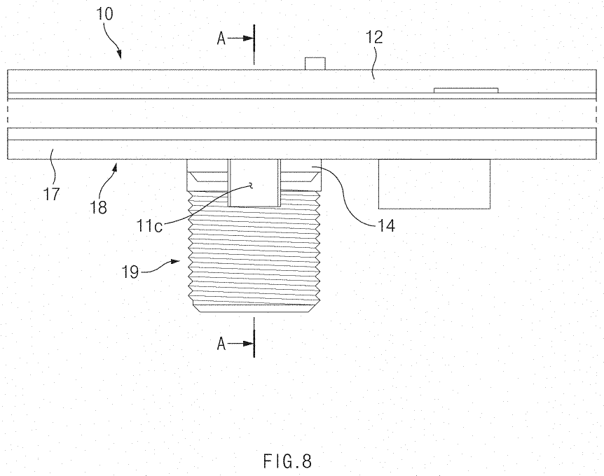

Referring to FIGS. 6-9, the antenna base 10 may have a mounting projection 14 protruding downwardly from the bottom surface 18 of the antenna base 10. The cavity 11 may be defined in the mounting projection 14. Referring to FIG. 8, the stud bolt 19 may be integrally connected to a bottom end of the mounting projection 14. Accordingly, the stud bolt 19 may be located below the bottom surface 18 of the antenna base 10.

Referring to FIG. 9, the mounting projection 14 may have an inner peripheral surface 14a and an outer peripheral surface 14b. A seat surface 14c may be provided on a top end surface of the mounting projection 14. As the seat surface 14c of the mounting projection 14 is recessed from the top surface 13 of the antenna base 10 toward the bottom surface 18 of the antenna base 10, the upper cavity 11a may be defined by the seat surface 14c of the mounting projection 14. The stud bolt 19 may have an inner peripheral surface 19a and an outer peripheral surface. An external thread 19b may be provided on the outer peripheral surface of the stud bolt 19. The center cavity 11b may be defined in the center of the mounting projection 14. The center cavity 11b may extend along a central axis of the mounting projection 14 and a central axis of the stud bolt 19. The inner peripheral surface 14a of the mounting projection 14 and the inner peripheral surface 19a of the stud bolt 19 may define the center cavity 11b. The pair of edge cavities 11c may be symmetrical to each other with respect to the central axis of the mounting projection 14. Each edge cavity 11c may be recessed from the outer peripheral surface 14b of the mounting projection 14 toward the inner peripheral surface 14a of the mounting projection 14. The edge cavity 11c may be open to the outside of the mounting projection 14.

The antenna base 10 may have a retention shoulder 41 provided in the center cavity 11b. The retention shoulder 41 may protrude from the inner peripheral surface 14a of the mounting projection 14 toward the center cavity 11b and the retention shoulder 41 may have a flat engagement surface 41a. The retention shoulder 41 may extend along the inner peripheral surface 14a of the mounting projection 14. In particular, the retention shoulder 41 may be located between the inner peripheral surface 14a of the mounting projection 14 and the inner peripheral surface 19a of the stud bolt 19.

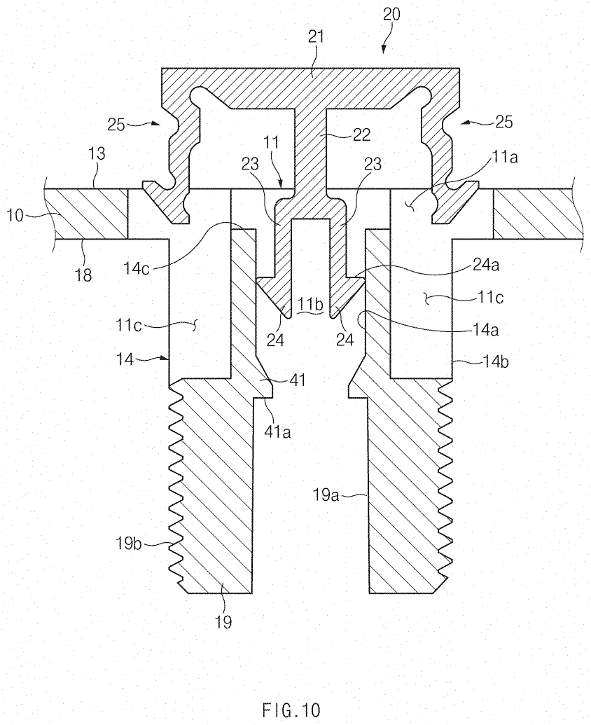

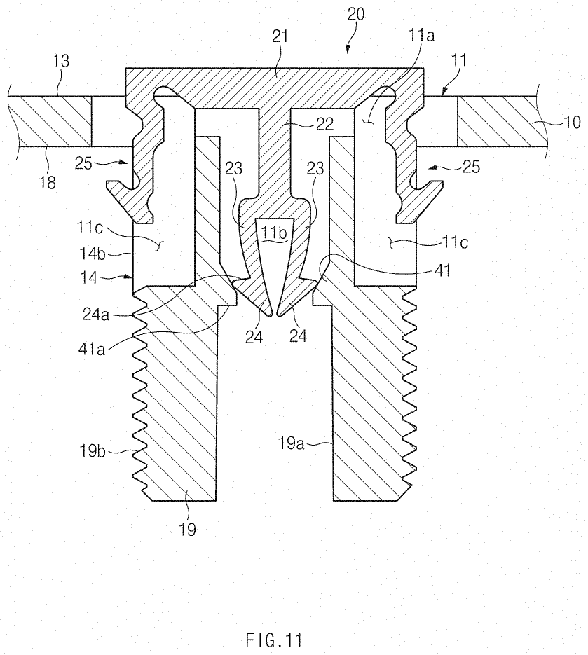

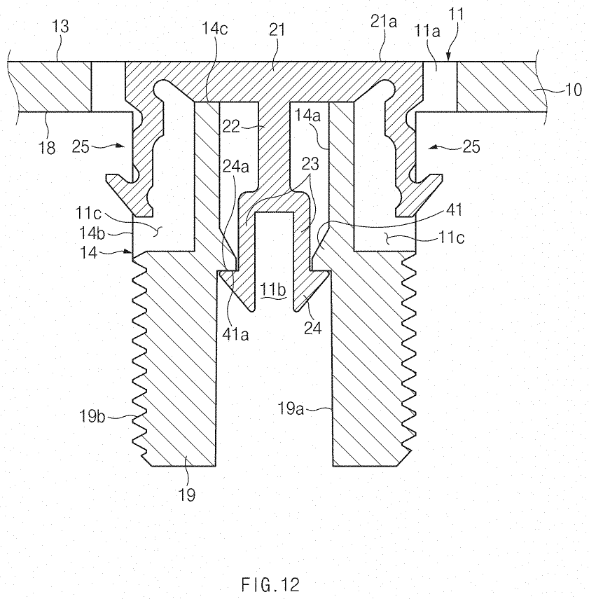

Referring to FIGS. 10-12, the temporary mounting member 20 may be received in the cavity 11 of the antenna base 10. FIG. 10 illustrates a state in which the center legs 23 and the edge legs 25 of the temporary mounting member 20 are initially received in the cavity 11. FIG. 11 illustrates a state in which the center legs 23 of the temporary mounting member 20 are bent by the retention shoulder 41. FIG. 12 illustrates a state in which the temporary mounting member 20 has fully been received in the cavity 11.

When the temporary mounting member 20 is initially received in the cavity 11 as illustrated in FIG. 10, the center legs 23 and the edge legs 25 of the temporary mounting member 20 may not be deformed. As illustrated in FIG. 11, as the center retention barbs 24 of the temporary mounting member 20 come into contact with the retention shoulder 41 located in the center cavity 11b, the center legs 23 may be bent. As illustrated in FIG. 12, as the engagement surfaces 24a of the center retention barbs 24 are engaged with the engagement surface 41a of the retention shoulder 41, the center retention barbs 24 of the temporary mounting member 20 may be retained in the center cavity 11b by the retention shoulder 41. Thus, the temporary mounting member 20 may be fitted in the cavity 11.

Referring to FIG. 12, when the head 21 of the temporary mounting member 20 is received in the upper cavity 11a, a bottom surface of the head 21 of the temporary mounting member 20 may be seated on the seat surface 14c. The head 21 of the temporary mounting member 20 may have a thickness corresponding to a distance between the top surface 13 of the antenna base 10 and the seat surface 14c of the mounting projection 14 (that is, a thickness of the upper cavity 11a). When the head 21 of the temporary mounting member 20 is received in the upper cavity 11a, a top surface 21a of the head 21 may be flush with the top surface 13 of the antenna base 10.

Referring to FIGS. 2 and 6, the head 21 may have a positioning recess 26. Referring to FIGS. 6, 7, and 9, the antenna base 10 may have a positioning projection 16 protruding toward the cavity 11. The positioning projection 16 may be received in the positioning recess 26 of the temporary mounting member 20. The positioning projection 16 may have a shape and a size corresponding to those of the positioning recess 26. When the temporary mounting member 20 is received in the cavity 11, the positioning projection 16 may be fitted into the positioning recess 26 so that a mounting position of the temporary mounting member 20 may be accurately determined.

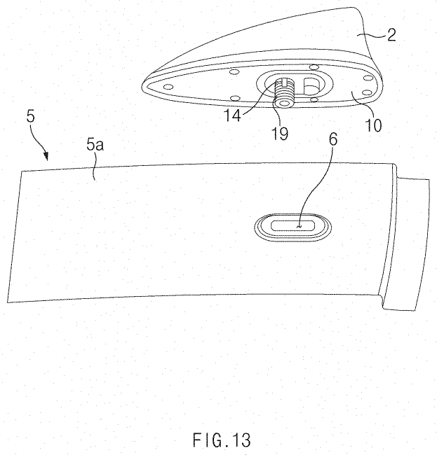

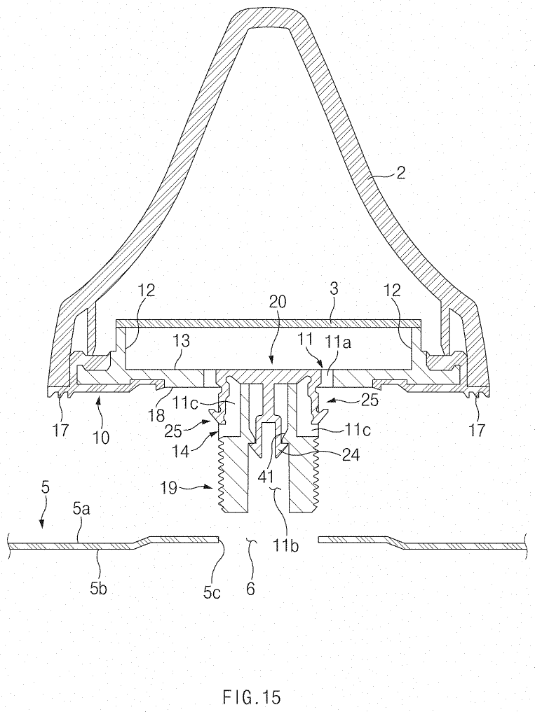

Referring to FIGS. 13 and 15, the antenna circuit board 3 may be supported by the support wall 12 of the antenna base 10. The antenna cover 2 may be mounted on the antenna base 10 to cover the antenna circuit board 3. The temporary mounting member 20 may be received in the cavity 11 of the antenna base 10. After the antenna cover 2, the antenna circuit board 3, and the temporary mounting member 20 are mounted on the antenna base 10, the temporary mounting member 20 and the stud bolt 19 of the antenna base 10 may be inserted into a hole 6 of the roof 5 of the vehicle body.

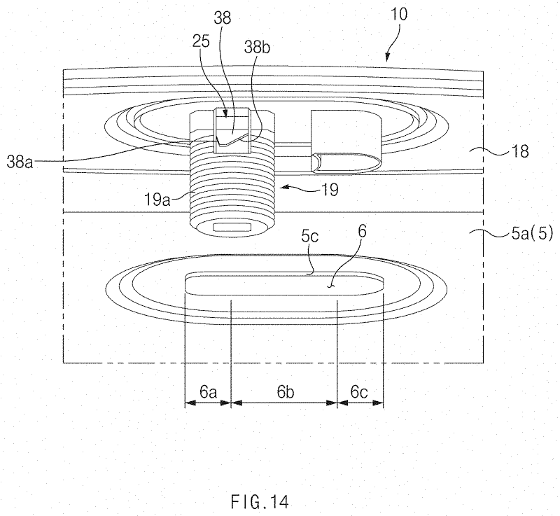

Referring to FIG. 14, the hole 6 of the roof 5 may include a front area 6a facing the front of the antenna and the front of the vehicle, a rear area 6c facing the rear of the antenna and the rear of the vehicle, and a center area 6b located between the front area 6a and the rear area 6c. A peripheral edge of the front area 6a of the hole 6 may have higher stiffness than a peripheral edge of the center area 6b of the hole 6, and the stud bolt 19 may be inserted into the front area 6a of the hole 6. When the stud bolt 19 is inserted into the front area 6a of the hole 6, the edge leg 25 of the temporary mounting member 20 may come into contact with the peripheral edge of the front area 6a in the hole 6 of the roof 5.

When the temporary mounting member 20 passes through the hole 6 of the roof 5, the first inclined surface 38a of the edge retention barb 38 may first come into contact with the peripheral edge of the front area 6a. Accordingly, the edge leg 25 may be deformed toward the rear of the temporary mounting member 20. As the first inclined surface 38a having a relatively steep slope comes into contact with the peripheral edge of the front area 6a, deformation of the roof 5 may be minimized, and deformation and restoration of the edge leg 25 of the temporary mounting member 20 may be facilitated. For example, as the slope of the first inclined surface 38a is made at an acute angle of less than 45°, the deformation of the roof 5 may be further reduced, and the deformation and restoration of the edge leg 25 may be easier.

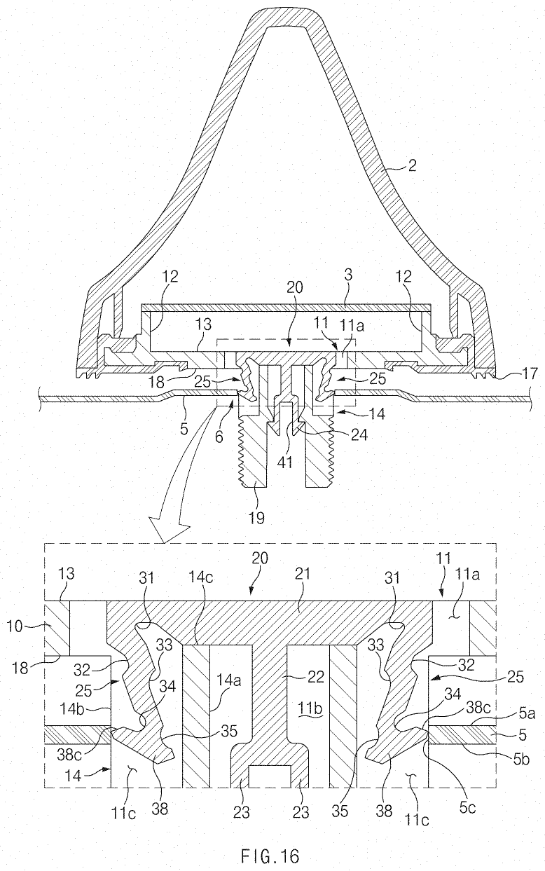

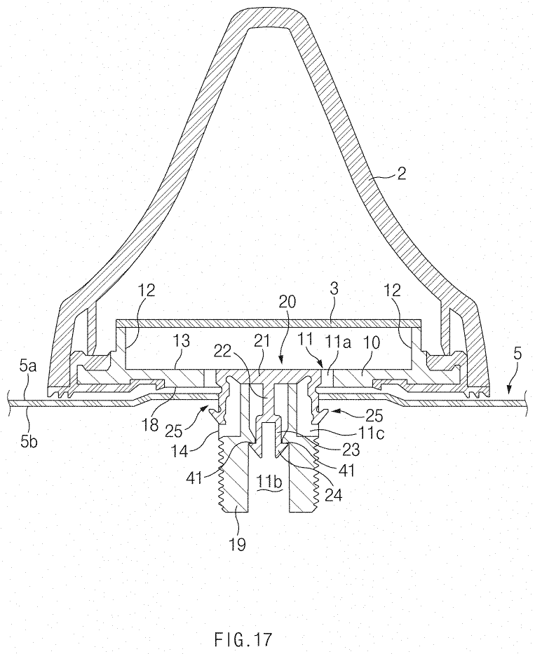

FIGS. 15-17 illustrate a process of sequentially inserting the temporary mounting member 20 and the stud bolt 19 of the antenna base 10 into the hole 6 of the roof 5. FIG. 15 illustrates a state before the temporary mounting member 20 and the stud bolt 19 of the antenna base 10 are inserted into the hole 6 of the roof 5. FIG. 16 illustrates a state in which the temporary mounting member 20 and the stud bolt 19 of the antenna base 10 are passing through the hole 6 of the roof 5. FIG. 17 illustrates a state in which the temporary mounting member 20 and the stud bolt 19 of the antenna base 10 have fully been inserted into the hole 6 of the roof 5.

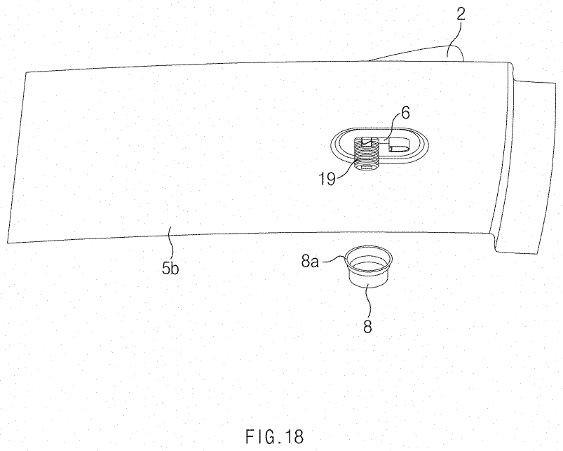

As illustrated in FIG. 15, the stud bolt 19 of the antenna base 10 may move toward the hole 6 of the roof 5. Then, as illustrated in FIG. 16, when the stud bolt 19 of the antenna base 10 passes through the hole 6 of the roof 5, the temporary mounting member 20 may come into contact with a peripheral edge 5c of the hole 6 of the roof 5, and the edge legs 25 of the temporary mounting member 20 may be bent by the peripheral edge 5c of the hole 6. As illustrated in an enlarged view of FIG. 16, the first inner recess 31 may be compressed, the first outer recess 32 may be extended (stretched), the second inner recess may be compressed, the second outer recess 34 may be compressed, and the third inner recess 35 may be extended. Thus, each edge leg 25 may easily be deformed. Referring to FIGS. 17 and 18, when the sealing portion 17 of the antenna base 10 contacts the top surface 5a of the roof 5, the temporary mounting member 20 and the stud bolt 19 of the antenna base 10 may be fully inserted into the hole 6 of the roof 5 so that the stud bolt 19 may protrude below the bottom surface 5b of the roof 5. Thus, the antenna base 10 may be temporarily assembled to the roof 5 by the temporary mounting member 20, and the stud bolt 19 may fully extend downward through the hole 6 of the roof 5.

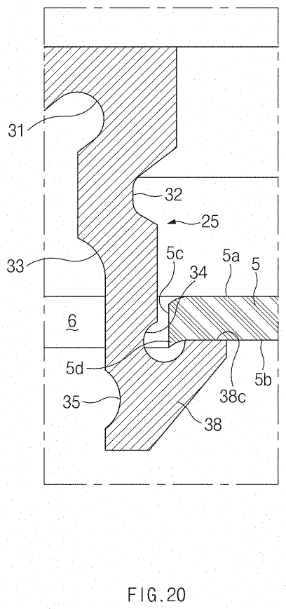

Referring to FIG. 19, after the stud bolt 19 fully extends through the hole 6 of the roof 5, the nut 8 may be tightly fastened to the stud bolt 19 using a tool so that the antenna base 10 may be fully connected to the roof 5. The nut 8 may have a head 8a provided on a top end thereof. When the nut 8 is tightly fastened to the stud bolt 19, the head 8a of the nut 8 may press the bottom surface 5b of the roof 5, and the antenna base 10 may move upward. Referring to FIG. 20, when the nut 8 is tightly fastened to the stud bolt 19, the engagement surface 38c of the edge retention barb 38 of each edge leg 25 may be engaged with the bottom surface 5b of the roof 5 adjacent to the hole 6 so that the antenna base 10 may be prevented from being separated from the hole 6 of the roof 5. In particular, as the engagement surface 38c of the edge retention barb 38 is engaged with the bottom surface 5b of the roof 5, the temporary mounting member 20 and the antenna base 10 may be prevented from being separated from the roof 5. By adding an engagement force between the edge retention barb 38 of the temporary mounting member 20 and the bottom surface 5b of the roof 5 to a fastening force between the stud bolt 19 and the nut 8, joining stiffness between the antenna base 10 and the roof 5 may be significantly improved.

Referring to FIG. 20, the roof 5 may have a stopper projection 5d protruding downwardly from the bottom surface 5b of the roof 5 along the peripheral edge 5c of the hole 6. As the stopper projection 5d is located within the second outer recess 34 of the edge leg 25, a movement of the engagement surface 38c of the edge retention barb 38 may be limited by the stopper projection 5d. Thus, the edge leg 25 of the temporary mounting member 20 may be prevented from being separated from the hole 6 of the roof 5.

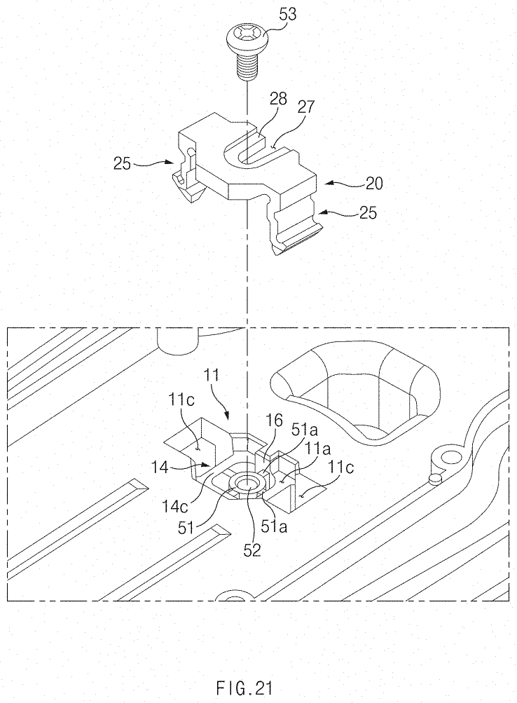

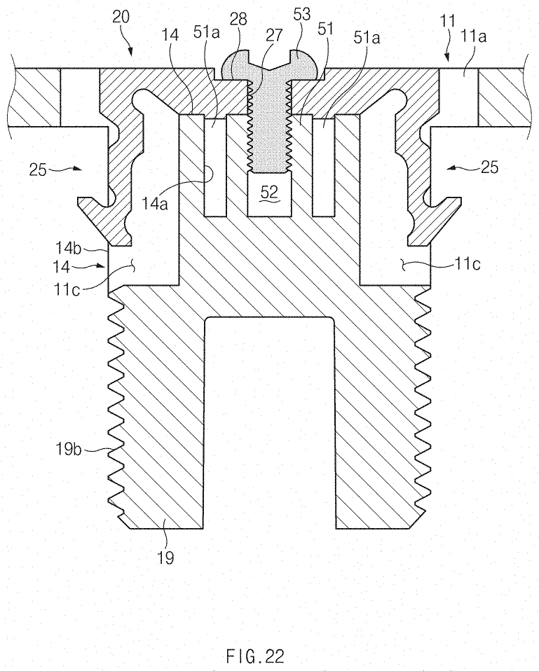

FIGS. 21 and 22 illustrate a vehicle antenna mounting system according to another embodiment of the present disclosure.

Referring to FIGS. 21 and 22, the temporary mounting member 20 may have an opening 27 provided in the head 21, and a support surface 28 may be provided around the opening 27. The antenna base 10 may have a boss 51 provided in the center of the cavity 11, and the boss 51 may have a hole 52 into which a screw 53 is screwed. The boss 51 may be integrally connected to the inner peripheral surface 14a of the mounting projection 14 through a rib 51a. As the screw 53 passes through the opening 27 of the temporary mounting member 20 and is screwed into the hole 52 of the boss 51, a head portion of the screw 53 may be supported to the support surface 28 of the temporary mounting member 20.

According to the embodiment illustrated in FIGS. 21 and 22, the temporary mounting member 20 may not include the center extension portion 22 and the pair of center legs 23 but may include the pair of edge legs 25 extending from both edges of the head 21 as in the previous embodiment. The other elements in this embodiment may be the same as or similar to those in the previous embodiment.

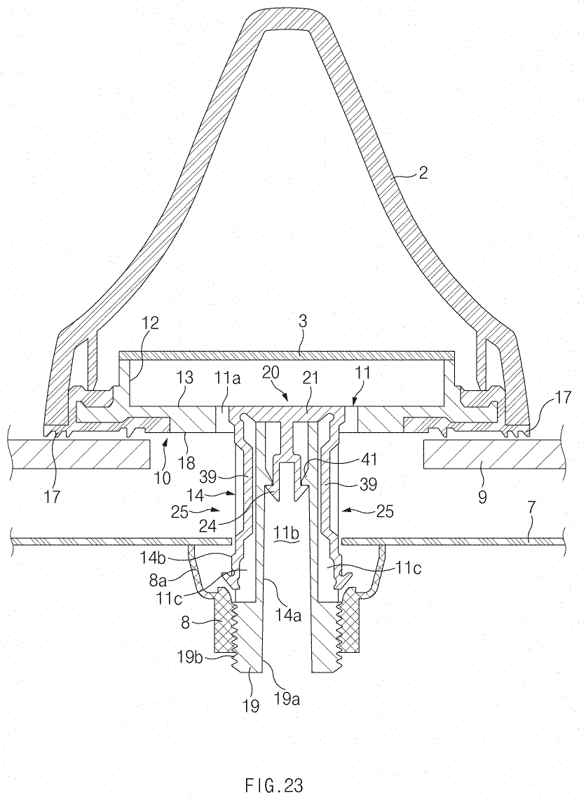

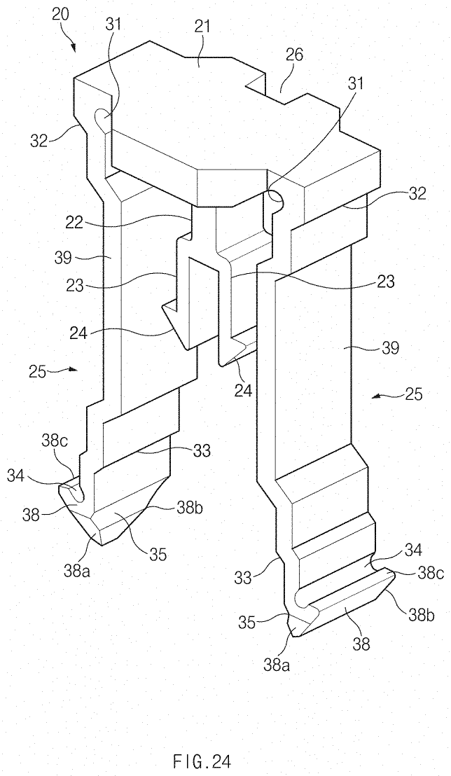

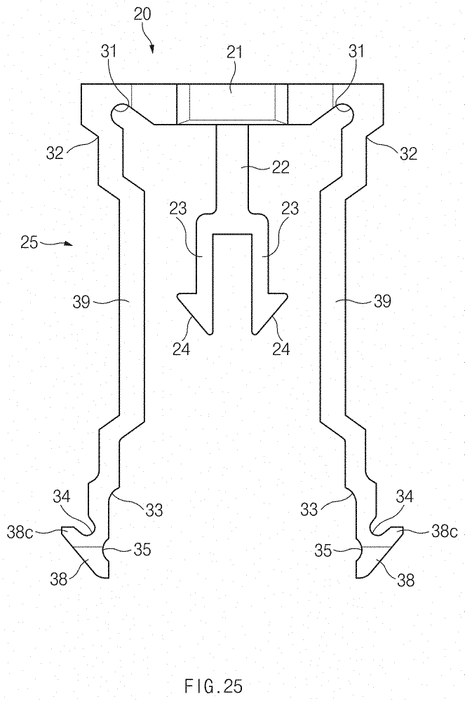

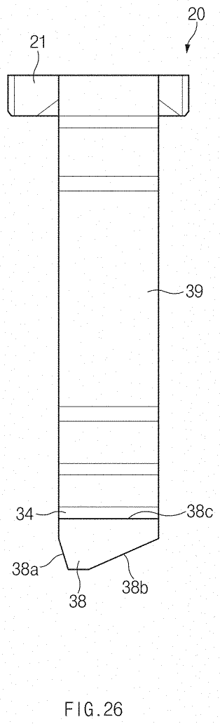

FIGS. 23-26 illustrate a vehicle antenna mounting system according to another embodiment of the present disclosure.

FIG. 23 illustrates a roof structure having a panoramic roof 9 and a roof reinforcement 7. The panoramic roof 9 may be disposed above the roof reinforcement 7, and the panoramic roof 9 may be made of a tempered glass material. The sealing portion 17 of the antenna base 10 may contact a top surface of the panoramic roof 9. The roof reinforcement 7 may be made of a metallic material. As the nut 8 is tightly fastened to the stud bolt 19, the head 8a of the nut 8 may come into contact with a bottom surface of the roof reinforcement 7. In this regard, the temporary mounting member 20 may have a predetermined length corresponding to a gap between the panoramic roof 9 and the roof reinforcement 7. Specifically, each edge leg 25 of the temporary mounting member 20 may further include a straight portion 39 extending vertically. The straight portion 39 may have a predetermined length corresponding to the gap between the panoramic roof 9 and the roof reinforcement 7. The straight portion 39 may extend vertically between the first outer recess 32 and the second inner recess 33.

As set forth above, the vehicle antenna mounting system according to embodiments of the present disclosure may prevent the antenna base from being separated from the roof by tightly fastening the antenna base using the fasteners (the stud bolt and the nut) in a state in which the antenna base and the roof are temporarily assembled by the temporary mounting member, thereby improving the joining stiffness between the antenna base and the roof.

Hereinabove, although the present disclosure has been described with reference to several embodiments and the accompanying drawings, the present disclosure is not limited thereto. The embodiments may be variously modified and altered by those having ordinary skill in the art to which the present disclosure pertains without departing from the spirit and scope of the present disclosure claimed in the following claims.

What is claimed is:

1. A vehicle antenna mounting system, comprising:
an antenna circuit board;
an antenna base supporting the antenna circuit board;
an antenna cover covering the antenna circuit board; and
a temporary mounting member temporarily mounting the antenna base on a roof of a vehicle body,
wherein the antenna base has a mounting projection protruding downwardly from a bottom surface of the antenna base, and a cavity defined in the mounting projection,
the temporary mounting member is received in the cavity, and
the roof has a hole into which the temporary mounting member is inserted.

2. The vehicle antenna mounting system according to claim 1, wherein the temporary mounting member includes:
a head;
a pair of center legs extending from the center of the head; and
a pair of edge legs extending from both edges of the head, respectively.

3. The vehicle antenna mounting system according to claim 2, wherein the pair of center legs are spaced apart from each other and be parallel to each other,
wherein each center leg is elastically bent and connected to the head, and
wherein the center leg has a center retention barb provided on a bottom end thereof.

4. The vehicle antenna mounting system according to claim 2, wherein each edge leg has an edge retention barb provided on a bottom end thereof.

5. The vehicle antenna mounting system according to claim 2, wherein each edge leg has an inner surface facing the pair of center legs and an outer surface facing the outside of the head, and
wherein the edge leg has a plurality of inner recesses provided on the inner surface, and a plurality of outer recesses provided on the outer surface.

6. The vehicle antenna mounting system according to claim 5, wherein the plurality of inner recesses is recessed from the inner surface toward the outer surface, and
wherein the plurality of outer recesses is recessed from the outer surface toward the inner surface.

7. The vehicle antenna mounting system according to claim 4, wherein the edge retention barb has a first inclined surface and a second inclined surface opposing the first inclined surface, and
wherein a slope of the first inclined surface is steeper than that of the second inclined surface.

8. The vehicle antenna mounting system according to claim 2, wherein the head has a positioning recess,
wherein the antenna base has a positioning projection protruding toward the cavity, and
wherein, when the temporary mounting member is received in the cavity, the positioning projection is fitted into the positioning recess.

9. The vehicle antenna mounting system according to claim 2, wherein the cavity includes:
an upper cavity receiving the head;
a center cavity receiving the pair of center legs; and
a pair of edge cavities receiving the pair of edge legs, respectively.

10. The vehicle antenna mounting system according to claim 9, wherein the cavity includes a retention shoulder provided in the center cavity, and
wherein the pair of center legs are engaged with the retention shoulder.

11. The vehicle antenna mounting system according to claim 9, wherein, when the head is received in the upper cavity, a top surface of the head is flush with a top surface of the antenna base.

12. The vehicle antenna mounting system according to claim 2, wherein each edge leg further includes a straight portion extending vertically.

13. The vehicle antenna mounting system according to claim 1, wherein the temporary mounting member has a head and an opening provided in the head, and includes a pair of edge legs extending from both edges of the head, respectively, and wherein a screw passes through the opening and is screwed into the antenna base.

14. The vehicle antenna mounting system according to claim 1, further comprising a stopper projection protruding downwardly from a bottom surface of the roof along a peripheral edge of the hole.
